(19) United States
(12) Patent Application Publication
(10) Pub. No.: US 2008/0306824 A1
(43) Pub. Date: Dec. 11, 2008

(54) Empty Space Advertising Engine

(76) Inventor: David C. Parkinson, Seattle, WA (US)

Correspondence Address: John Whitaker;Whitaker Law Group, 755 WINSLOW WAY EAST, Suite 100, BAINBRIDGE ISLAND, WA, 98110, US

(21) Appl. No.: 12/133,510

(22) Filed: Jun. 5, 2008

Related U.S. Application Data
(60) Provisional application No. 60/943,010, filed on Jun. 8, 2007.

(51) Int. Cl. G06Q 30/00; G06Q 10/00

(52) U.S. Cl. 705/14

(57) ABSTRACT

A web page is enabled to display advertisements in the empty space that is present in conjunction with normal content. Usage data including both positive and negative feedback is collected and stored on a server.

### RELATED APPLICATIONS

This patent application claims priority to co-pending Provisional Patent Application No. 60/943,010 filed on Jun. 8, 2007 entitled Empty Space Advertising Engine.

### BACKGROUND

1. Technical Field

The present invention relates to the field of online computing. More specifically, the invention relates to the field of online advertising.

2. Discussion of Related Technology

The substance of web pages can be largely divided into two categories: content and empty space. Content includes elements such as text, links, images, and rich media. Empty space (also known as “white space” or “filler”) refers to regions on a web page where no content exists. Empty space is used to create space between content, to draw attention to content, and to increase the readability of a web page. It would be difficult indeed to use a website that consisted entirely of content.

Each element of content described above can be monetized with existing advertising products. Intellitxt and Kontera monetize text elements, AdBrite's BritePic monetizes image elements, Google's AdSense monetizes link elements, and companies like Eyeblaster and DoubleClick monetize rich media. However, the value of empty space has never before been monetized.

A system for electronic advertising that is worthy of today's technology has eluded those skilled in the art, until now.

### SUMMARY

This summary is provided to introduce a selection of concepts in a simplified form that are further described below in the Detailed Description section. This summary is not intended to identify key features or essential features of the claimed subject matter, nor is it intended to be used to limit the scope of the claimed subject matter.

The Empty Space Advertising Engine described herein turns a web page's empty space into revenue for the site owner by serving ads in the empty space of web pages—regions that were not previously monetized. The Engine detects content and displays advertisements in the empty space regions where content does not exist, thus maximizing revenue for site owners.

Advertisers are looking for more than new methods of serving advertisements. They want to find out how an ad they purchased is performing. Until now, the online ad serving industry has relied upon positive feedback such as number of ad impressions, clicks, views, interactions, and purchases. In addition to these analytics, the Engine delivers negative feedback. Negative feedback is evidence that the user does not like, does not want to see, or does not want to interact with a given advertisement. With this data in hand, advertisers can determine which ads users don't like. From these conclusions, an advertiser can rapidly iterate their online campaign by selecting ads that the majority of users like and that perform well. By providing both positive and negative feedback to advertisers, they can increase their campaign's return on investment.

According to aspects of various described embodiments, implementations are provided for enabling advertisements delivered in the empty space of web pages. Briefly stated, a web browsing agent on a client computer loads a web page that has opted to serve empty space advertisements. When the web page loads, client side executable code embedded in the web page executes via a client side code interpreter. The code requests an appropriate ad to be served from an ad server. Once an ad is obtained, a empty space detection system determines the content elements from empty space. As the user of the client computer interacts with the web page, the presentation system presents the ad in a visually appealing manner. Finally, the usage data is tracked for the advertisements and reported to the ad server.

### BRIEF DESCRIPTION OF THE DRAWINGS

Many of the attendant advantages of this invention will become more readily appreciated as the same becomes better understood by reference to the following detailed description, when taken in conjunction with the accompanying drawings, briefly described here.

FIG. 1 is a functional block diagram of a network environment in which implementations of the invention are particularly applicable.

FIG. 2 is a functional block diagram generally illustrating an ad server as introduced above in conjunction with FIG. 1.

FIG. 3 is a functional block diagram generally illustrating components of the client computer introduced above in conjunction with FIG. 1.

FIG. 4 is a functional block diagram generally illustrating the ad module with greater detail on the presentation component introduced in conjunction with FIG. 5.

FIG. 5 is a functional block diagram generally illustrating the client side code module with greater detail on the presentation component introduced above in conjunction with FIG. 2 and FIG. 3.

FIG. 6 is a functional block diagram of a sample web page generally illustrating the distinction between content and empty space.

FIG. 7 is a functional block diagram of a web page generally illustrating behaviors of the advertisement.

FIG. 8 is a UI diagram generally illustrating the categories of ad formats: text, image, and feedback.

Embodiments of the invention will now be described in detail with reference to these Figures wherein like numerals refer to like elements throughout.

### DETAILED DESCRIPTION

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented operations running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Briefly stated, a web browsing agent on a client computer loads a web page that serves empty space advertisements. When the web page loads, client side executable code embedded in the web page executes. The code requests an appropriate ad to be served within empty space on the web page.

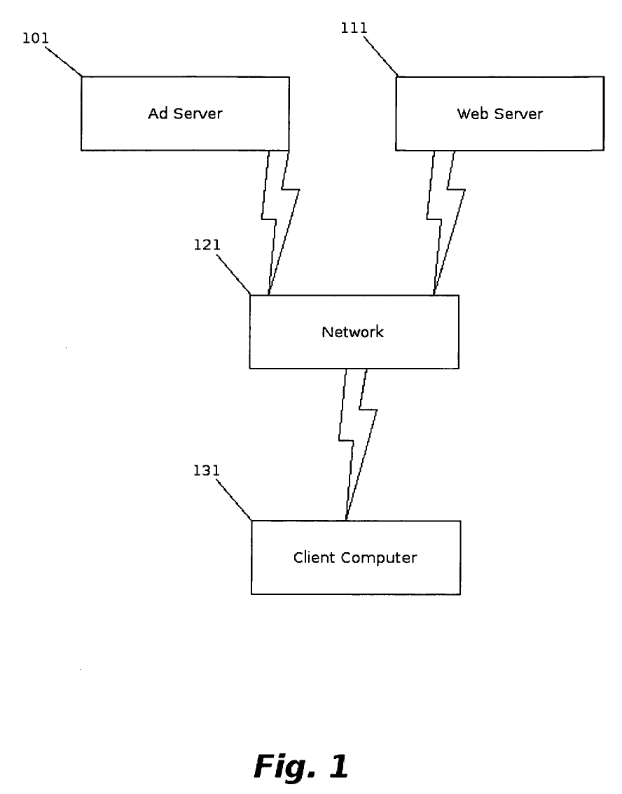

FIG. 1 is a functional block diagram of a network environment in which implementations of the invention are particularly applicable. As illustrated, a remote advertisement server (ad server 101) and a client computer 131 are coupled to a wide area network 121, such as the Internet. The ad server 101 is a computing system that is used to provide or make available advertisements used in electronic advertising, such as in connection with Web pages that are viewed while browsing the Web. Electronic advertising is familiar to most users of the Internet.

Generally stated, the client computer 131 includes components that retrieve information from remote locations, such as other computers connected to the network 121, and present that information for review on the client computer 131. This enables users of the client computer 131 to “browse” or “surf” information or content provided by other computers connected to the network 121. Examples of the type of content that can be viewed while online are endless, and include news reports, stock quotes, streaming media (e.g., music and video), and the like. Generally, the client computer 131 retrieves content from various sources, such as the ad server 101 or the web server 111, over the network 121. In this particular implementation, the web pages served through web server 111 are configured to display advertisements in empty space of the web pages. This feature is accomplished, in one embodiment, by including client-side executable code in the content served by the web server 111. The client-side executable code may reference advertisements served by the ad server 101, or elsewhere. Moreover, the client computer 131 may display the advertisements by executing the client side executable code using a client side code interpreter inside the context of a web browser agent on client computer 131.

It should be noted that the web server 111 and the ad server 101 are illustrated as two separate entities for simplicity of discussion and to present a complete understanding of the functional components of this embodiment. In other implementations, the functionality of the web server 111 and the ad server 101 could be combined into a single physical component, implemented using different physical components, or even distributed over multiple components.

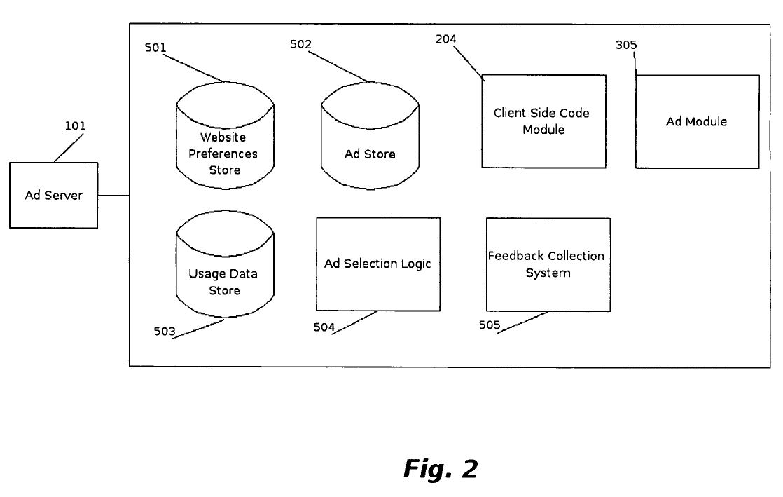

FIG. 2 is a functional block diagram generally illustrating in greater detail the ad server 101 introduced above in conjunction with FIG. 1. In this particular implementation, the ad server 101 includes several components that support electronic, online advertising. The ad server 101 may include many other components in addition to those described here, but which are not relevant to the present discussion.

The ad server 101 includes an ad store 502, which is a storage component in which resides electronic advertisements, such as text, images, multimedia files, scripts, link destinations, size dimensions, and the like. Each advertisement may be associated with a customer, which is any entity that may provide advertisements to the ad server 101 for presentation, or may request the presentation of an advertisement on its behalf. Commonly, the customer agrees to provide compensation to the ad server 101 operator based on a number of times its associated advertisements are presented.

The ad server 101 also includes ad selection logic 504, which is an executable component that is configured to respond to requests for an electronic advertisement by retrieving the appropriate advertisement from the ad store 502 and transmitting it to the requesting entity. The request may take any one or more of multiple forms, such as an Hyper Text Transfer Protocol (HTTP) request, or the like, issued in connection with viewing a Web page or other markup language content. The selection logic 504 includes routines or other decision making code that identifies which one or more advertisements to return in response to a request for the advertisement. The decision criteria may include such factors as advertiser's current balance, impressions, clicks, dismissals, category of requesting website, time of request, geographical location of the user, behavior patterns of the user, and likes or dislikes of the user as it attempts to find the most appropriate advertisement to display to the user. The ad selection logic 504 uses both the website preferences store 501, described below, and ad store 502 to select the best ad to be displayed.

A feedback collection system 505 is an executable component of the ad server 101 that is configured to monitor the usage of or requests for an advertisement. In this particular implementation, the system keeps track of each time an advertisement is accessed or requested. More specifically, the system may track each request to retrieve an advertisement from the ad server 101, and any ‘click-through’ information for each advertisement. In other words, while an advertisement is being presented or displayed, a user may select or click on the advertisement to investigate the subject matter of the advertisement. Because there may be more value to a customer when users click on an advertisement than simply view it, the system tracks that information, such as for billing purposes.

In this implementation, the system also tracks the number of times users “dismiss” an advertisement. A dismissal may be viewed as negative feedback that suggests users do not care for or like a particular advertisement. This feedback allows advertisers to improve their advertising campaign by not only promoting ads with a high approval ranking, but also by handling advertisements that have a high apparent disapproval rating. In this way, advertisers can rapidly iterate on their advertising campaign, choosing ads that have both a high click through rate as well as a low dismissal rate.

A usage data store 503 on the ad server 101 is a data storage component in which is stored the usage data collected by the feedback collection system 505. Examples of the types of data that may be stored include the number of times each advertisement has been presented or retrieved, the number of times a user followed a link associated with advertisement, the number of times the user dismissed the advertisement, the IP address of the user, the time the advertisement was served, feedback from the user in the case of a feedback ad, other empirical data for each advertisement, and the like.

A website preferences data store 501 on the ad server 101 stores preferences for the website that is requesting an advertisement. Website owners may customize the way advertisements appear throughout the web pages of their website. Examples of the customizations include the latency time for an advertisement to display, the regions that the ad may be displayed in, the formats of advertisements that are displayed, the categories of ads to be displayed, and competitive filters to prevent competitor's ads.

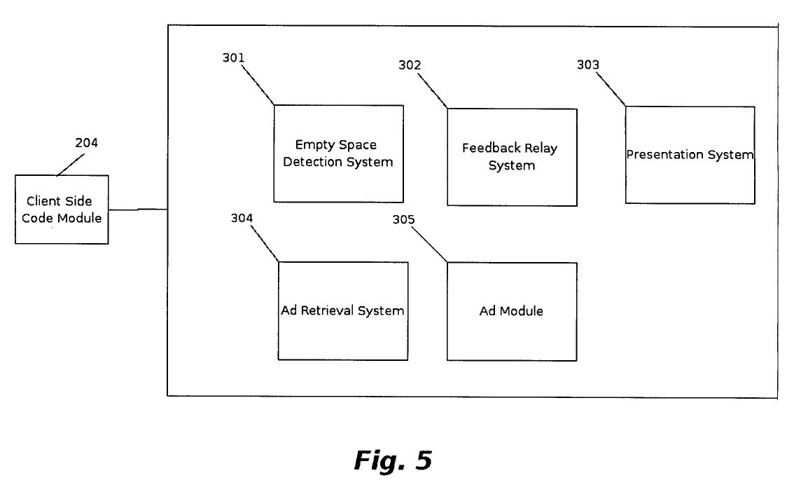

A client side code module 204 resides on the ad server 101. The client side code module 204 is executable code intended to run on the client computer 131. In one implementation, the client side code module 204 is a written in JavaScript (JS) and includes the systems for detecting empty space, retrieving advertisements, displaying advertisements, and sending usage data to the ad server 101. One implementation of an empty space detection system is described below in conjunction with FIG. 5, although many other implementations are possible. Alternate implementations could use other mechanisms, such as a rich client side executable framework like Flash, Silverlight, or Flex, to accomplish the same tasks.

In operation, a web page is requested from a client computer 131 which is then served from web server 111. The web page that is served references the client side code module 204 on the ad server 101 using a hyper text markup language (HTML) script “include” tag, or similar method. In addition, the web page contains initiation code 224 that uniquely identifies the publisher and websites using unique IDs. The client side code module is downloaded onto the client computer 131, and requests an advertisement from the ad server 101 via the ad selection logic 504. The ad selection logic 504 uses the website ID from the initiation code 224 to obtain the website preferences which are stored in the website preferences store 501. The ad selection logic 504 then determines the most appropriate ad to be served, and obtains an ad via the ad store 502. The ad selection logic then creates an ad module 305, and stores publisher preferences, ad content, ad layout, and destination logic inside the ad module 305 and returns this module to the client computer 131. The feedback collection system 505 captures usage data generated by the client computer 131 as it occurs, and is stored in the usage data store 503.

The components described here are merely illustrative of the type and nature of components that may be used on the ad server 101 to implement the techniques and functionality just described. In alternative embodiments, other components may be used, certain functions may be combined into fewer components, certain functions may be divided among different components, additional functions may be incorporated into these or other components, and the like.

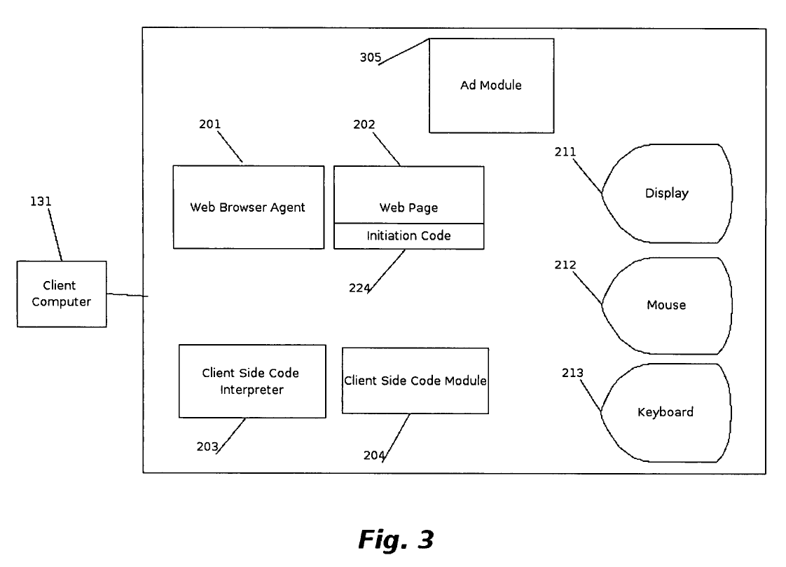

FIG. 3 is a functional block diagram generally illustrating components of the client computer 131 introduced above in conjunction with FIG. 1. In this particular implementation, the client computer 131 includes several components that enable the display of empty space electronic advertising. In accordance with this implementation, the components enable advertisements to appear in the empty space of web pages without compromising traditional advertisements that appear in the content area of a website.

The client computer 131 includes several components that are also present on the ad server 101. Either or both the ad module 305 and/or client side code module 204 may be downloaded to the to the client computer 131 via the web browsing agent. Both of these components are downloaded as they are linked to via a web page 202 that is first downloaded to the client computer 131 via web browsing agent 201.

A web browser agent 201 is included on the client computer 131. The web browser agent is responsible for downloading web pages such as 202 from the web server 111. The web browser agent 201 communicates with the ad server 101 in three ways: it downloads the client side code module 204, it requests an ad to display via the ad selection logic 504, and it sends usage data to the feedback collection system 505. It is important to consider that web browser agents are available in many different forms on many platforms including Microsoft Windows, Linux, Apple OS X, and many others. Thus, systems may be developed that are either platform specific and work on only a select few platforms, or systems may be developed that are entirely platform agnostic using cross-platform components.

In this implementation, the client computer 131 also includes a client side code interpreter 203. The interpreter is part of the web browser agent 201 and runs inside the same process and memory space as the web browser agent 201. As with most interpreters, the interpreter executes code such as the client side code module 204, but does not need to compile code. The interpreter provides an execution context for the client side code module 204. Examples of client side code interpreters include JavaScript, Flex, Flash, Shockwave, and Silverlight, among many others.

The client computer 131 also includes common input and output paradigms. Both the mouse 212 and the keyboard 213 allow the user to interact with the empty space advertisements, and generate the usage data that the client side code module 204 sends to the ad server's feedback collection system 505. The display 211 is used to display the advertisements to the user so that they may view and interact with the advertisements using the above input methods.

In the operation of the client computer 131, a web browser agent 201 requests a web page from the web server 111. The web page 202 downloaded references the client side code module 204 and causes the web browser agent 201 to download the client side code module 204. The client side code interpreter 203 executes the client side code module in the context of the web browser agent 201. With both the web page's initiation code 224 (that uniquely identifies the website and publisher), and client side code module, an ad is requested from the ad server 101 using the ad selection logic 504. The ad server 101 responds by returning the ad module 305 to the client side code module 204. Next, the client side code module 204 uses the ad module 305 to determine which content to render on display 211. The client side code module 204 also monitors input methods such as the mouse 212 and keyboard 213, sending usage data asynchronously to the feedback collection system 505 as well as adjusting the presentation of the advertisement.

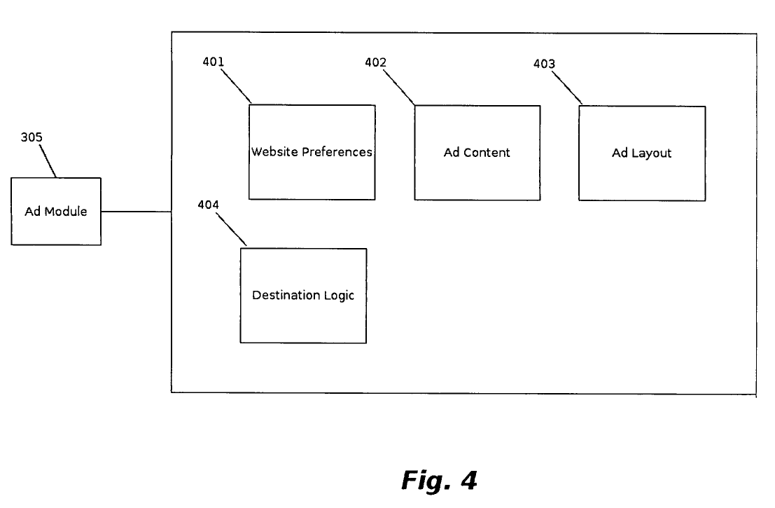

FIG. 4 is a functional block diagram generally illustrating the ad module 305 in conjunction with its introduction in FIG. 2. Components within the ad module 305 provide important content and rendering information that the client side code module 204 will use to render the ad.

The ad module 305 may include website preferences 401 which were obtained from the ad server 101. The website preferences are set by the operator of the website and help determine how the presentation system 303 displays the advertisement. Examples of such preferences include: appropriate locations that the ad may display, the latency between when the ad is loaded and when it is displayed in the empty space, whether the ad is a mouse tracking ad or a fixed margin ad, among many others. The presentation system 303 that will subsequently be described as part of the client side code module 204 and will provide additional clarity.

The ad module 305 also includes ad content 402. Examples of the content are limitless, and generally include any form of data that can be displayed to a user of the client computer 131. For instance, the content may include articles or text, such as the news, multimedia content, any form of markup based information, weather and/or stock reports, financial or business updates, images, and the like. One common characteristic of the content is that the content is amenable to presentation in a dynamic layout environment. Advertisements that appear may contain traditional content as well as sponsored advertisements. The theory here is that the user will more likely want to see the advertisements as sometimes they will be interesting content and other times, sponsored ads presented on behalf of paying advertisers.

The ad module 305 also contains an ad layout 403. The layout allows for a variety of content including the different types of content as described in the previous paragraph. It may be necessary to render the advertisements differently depending on content type. In one implementation, the layout is written using eXtensible HyperText Markup Lanuage (XHTML) and Cascading Style Sheets (CSS), but could be written in any language that can be displayed on display 211, using the web browser agent 201.

The destination logic 404 determines where the user should go if they act upon the advertisement. For example, if the user was to click the empty space of a web page, they may be taken to a given destination that the advertiser wants users to visit, such as the advertiser's product page. If the user were to click the advertisement itself, they may be redirected to a new destination. The type of content can change the destination. For example, if a popular video was displayed instead of a sponsored ad, clicking on the empty space of a website or the video itself may take the user to a larger version of the video. Finally, this component determines the method of redirection from the current web page. Based on the website preferences 401, the destination logic 404 affect the web browser agent 201 in different ways including: opening a new window, opening a new tab, navigating away from the current web page within the current window and tab, or any similar permutation.

FIG. 5 is a functional block diagram generally illustrating the client side code module 204 with greater detail than its introduction in FIG. 2. Components within the client side code module are configured to dynamically detect the layout of the content so as to present advertisements in the empty space of a web pages. The desired result is that given any web page, advertisements could be inserted dynamically after the page is already rendered in the regions where empty space exists. The ads should be presented in an exciting and visually appealing way to the user.

The components that are provided to pursue this goal include the ad module 305 as described above in conjunction with FIG. 3. The elements of the client side code module 204 use the data stored in the ad module 305, which contains the data and information about the advertisement to be displayed. Additionally, the display 211 of FIG. 3 allows advertisements to be rendered, displayed, presented, or the like. In one example, the display 211 may be a window associated with a web browser agent 201 or the like. The display 211 has display characteristics, such as width, height, color depth, and the like. These display characteristics may also change periodically, such as if a user resizes the window.

Before ads are displayed, the ad retrieval system 304 retrieves an advertisement from the ad server 101. The ad retrieval system takes as input the website ID and publisher ID from a given web page's initiation code 224, and sends this information to the ad server 101 which returns JavaScript Object Notation (JSON) that eventually becomes the ad module 305. As mentioned previously, the ad module 305 contains the information needed to display the ad. Because of single origin principle of browser security, retrieving an advertisement from an ad server via JavsaScript is not trivial. The ad retrieval system 304 described uses a dynamically generated HTML <script> tag which sends a Hypertext Text Transfer Protocol (HTTP) GET request to the ad server 101. The ad server 101 returns JSON which contains information about the ad to be displayed. When the JSON is returned, it calls a function found in the client side code module 204. By virtue of JavaScript, the JSON is parsed and is then treated as a normal JavaScript object. This object then becomes the ad module 204.

The client side code module 204 includes the empty space detection system 301. In one implementation for the cursor tracking ad 741 specifically, the system detects when the user user's mouse 212 position on web page 202 is currently selecting content or empty space. This detection allows the advertisement to appear at only the times where the user's mouse position is selecting empty space. This implementation works by registering mouse listeners and capturing mouse move events. These events occur with great frequency when the user moves their mouse 212. For every event, the system queries the event for the HTML tag associated with the current mouse movement. For example, if the user would move over text, the associated HTML tag might be a <p> for paragraph. In other cases, the HTML tag might be <body>. The system uses a blacklisting system where it checks the tag associated to the given mouse move event against a list of HTML tags which should not cause the advertisement to display. If the HTML tag returned is not within this blacklist, the system signals the presentation system 303 that the advertisement should be displayed. In alternate implementations, the operator of the website could determine an individual blacklist per website, which would be stored in the website preferences store 501 and retrieved via the website preferences 401 element of the ad module 305.

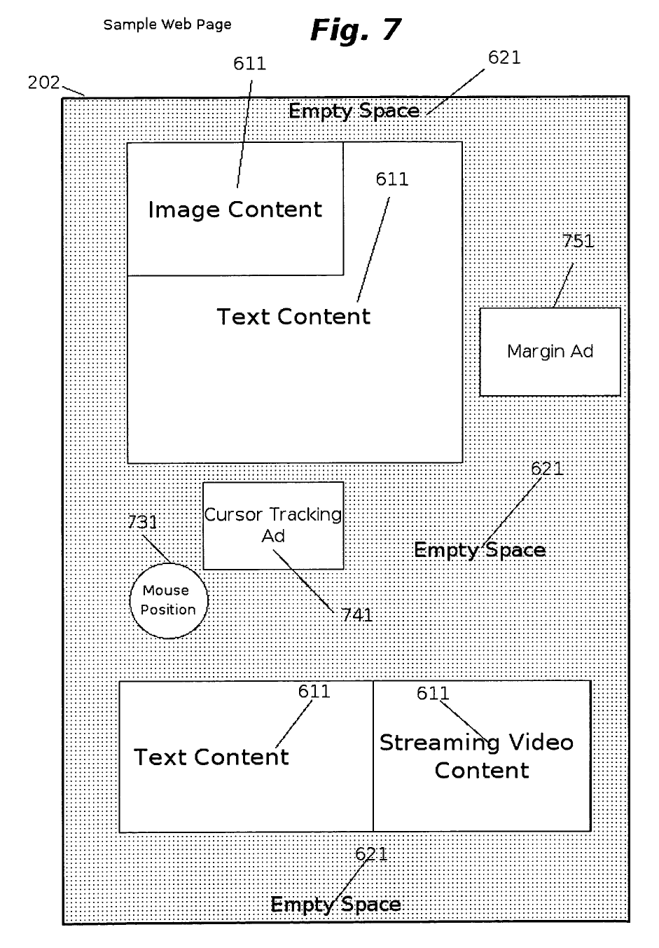

In an alternate implementation of the empty space detection system 301, the system is used for margin ads 751. As will be explained in the description of FIG. 7, margin ads are static advertisements that appear in the margins of a given web page. These ads are static in the fact that they do not follow the user's mouse position. In this implementation, the system not only detects empty space based on the user's current mouse position, but also detects empty space independent of the current mouse position. The previous implementation allows for detecting empty space based on mouse input, and this system is used to trigger the appearance or disappearance of a margin ad. When the empty space detection system 301 loads, it determines where the margins are for a given page so that a margin ad may be displayed when the user has moved their mouse position into the empty space. The system achieves this by scanning the HTML elements of a given web page and looking for tags which are not part of the blacklist mentioned previously. The system then calculates the dimensions of the ad to be displayed and the margins of the web page. The system takes these two inputs and determines where in the margins of a web page the ad may appear without overlapping other content. Although this discussion centers heavily around margin ads, it is important to note that the ad can appear in any position having empty space.

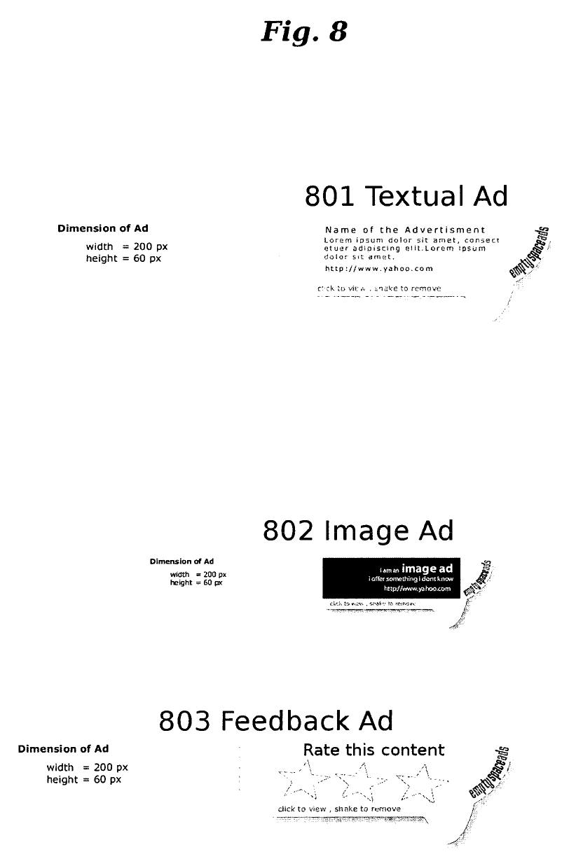

Another component of the client side code module 204 is the presentation component 320, introduced above. In this particular implementation, the presentation component 320 turns the data stored in the ad module 305 into an advertisement the user can see and interact with. FIG. 8 demonstrates sample advertisements that could be displayed and will be described in further detail below. The presentation system displays cursor tracking ads, which as will be described as element 741 in FIG. 7 are ads that follow the user's mouse position. The presentation component is triggered by the empty space detection system 301 which tells the component when to start and stop displaying advertisements. The presentation component 320 makes use of attractive effects such as fade-in and fade-out by adjusting the opacity of the ad element to be displayed. The presentation component 320 constantly updates the position of the ad based on the X and Y coordinates of the mouse events captured by the empty space detection system. When the empty space detection system detects the user's mouse position is over content, it signals the presentation system 320 to hide the current ad. And when the user moves their mouse to empty space, the empty space detection system 301 signals the presentation system 320 to display the current ad.

The feedback relay system 302 listens for user input data on a given web page from the mouse 212 and keyboard 213. The feedback relay system collects such information as the IP address of the user, the time the ad was displayed, how many times the ad displays, if the user dismissed the ad, how many mouse-overs (the user moves their mouse over the ad), if the user clicks the empty space or the ad, the feedback score that the user assesses the ad, among many other examples. As feedback is collected, it is asynchronously relayed to the feedback collection system 505 found on the ad server 101.

In addition to standard data that today's ad servers track, the feedback relay system 302 goes one step further, allowing the user to “dismiss” the advertisement. The user may dismiss an advertisement in various ways including shaking their mouse 212 vigorously within a limited amount of time, clicking a close button on the ad, depressing the middle or right button on their mouse 212, providing keyboard input, among many other methods. When the feedback relay system detects the user does not wish to see the advertisement, it may signal the ad retrieval system 304 to select an ad that the user may like more. In another implementation, the feedback relay system 302 may signal the presentation system to remove the ad from the display 211 in an entertaining way such as flinging the advertisement off the screen, symbolically “blowing up” the advertisement, or the like. The website preferences 401 stored in the ad module 305 may be used to decide what action to take when the user dismisses the ad, giving the website owner the highest level of control.

In operation, the empty space detection system 301 detects the empty space of a given web page and signals the presentation system when to display or hide the advertisement based on input from the user's mouse 212 and keyboard 213. As usage occurs, feedback is captured by the feedback relay system 302 and is promptly relayed to the ad server's feedback collection system 505 to be recorded in the usage data store 503. In the event that the user clicks on an ad or empty space, or otherwise indicates that they want to visit a given site, the ad module's destination logic 404 determines the appropriate action to take. In the case that the feedback relay system 302 detects the user's desire to dismiss the advertisement, the feedback relay system 302 informs the presentation system 303 to stop displaying the advertisement immediately, and informs the empty space detection system 301 that it should stop detecting empty space, and finally informs the feedback collection system 505 that the user dismissed the advertisement. An alternate approach is selecting an alternate ad to show the user. A quick query to the ad sever 101's ad selection logic 504 results in a new ad module 305 to be displayed via the presentation system 320.

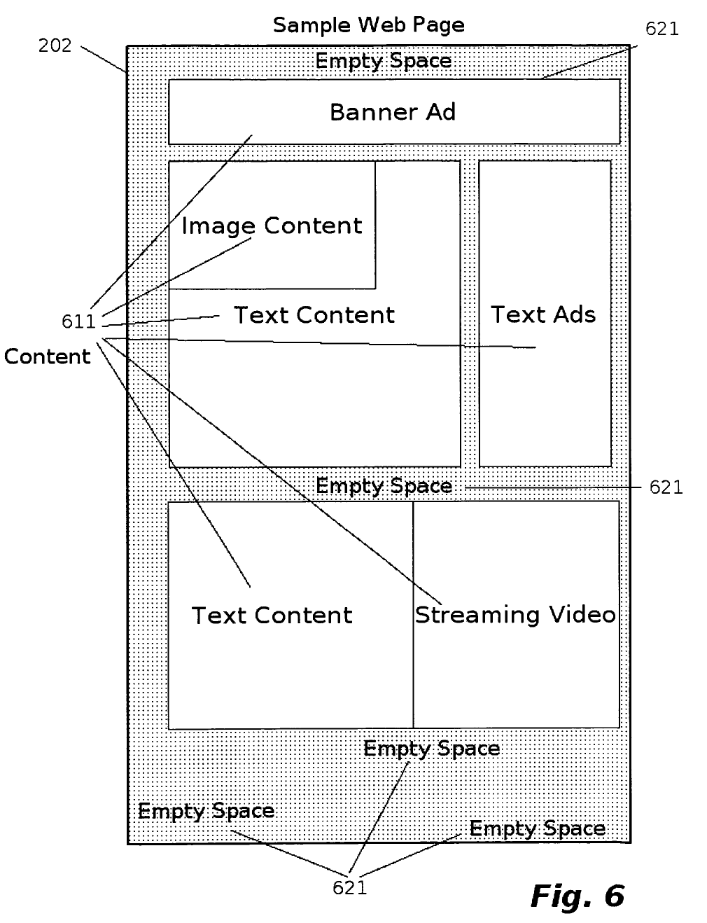

FIG. 6 is a block level diagram of a sample web page illustrating the difference between content and empty space in conjunction with FIG. 5 and FIG. 3. The sample web page 202 is shown in accordance with different types of content 611 and various examples of empty space 621. The diagram is only one sample of many different types of web pages, and shouldn't be interpreted in any limiting sense. The purpose of FIG. 6 is to call out the areas of a sample website in which empty space exists. Empty space advertisements could be placed in the empty space 621 to increase revenues for the website owner. Furthermore, multiple ads may appear within the empty space 621, and display is determined by where the user's mouse position 731 is located. Empty space near the top of a webpage may be priced higher than that at the bottom of a page, as users generally view the top of a web page more frequently.

Content such as the element 611 has been discussed at length in this application. Examples of content include banner advertisements, images, text, textual ads, link ads, streaming video, streaming audio, and rich media of different sorts. All of these examples have the common characteristic that when looking at a given page, they take up valuable space. They do so to provide value to the user or the website operator. For example, the user may enjoy looking at images or streaming video and thus the value of these elements is clear. Advertisements of different sorts may provide monetary value to the website operator and thus they have value as well.

Sample web page 202's empty space 621 however, has little to no value for either the user or the operator of the website. Empty space for the purposes of this application is generally defined as the areas on a given website on which there is no content. These areas are rife for advertisements to be displayed. The system described aims to place ads in the empty space 621 of web pages, and not to substantially interfere with the existing content on a page, although in alternate implementations, ads could overlap content. In implementations that are empty-space only, elaborate mechanisms may be provided to ensure that when users move their mouse over content, empty space advertisements are hidden immediately.

FIG. 7 is a block level diagram of a sample web page designed to illustrate the two behaviors of any empty space ad format. Many elements in FIG. 7 were previously described in FIG. 6 and will not be discussed again. While two ad behaviors are shown on one page, this does not indicate that both will occur at the same time, or even separately. Any permutation of ad behaviors is possible.

Mouse position 731 is illustrated on a sample web page. The mouse position may move all over a given web page as well as off a web page 202 or even outside the context of a web browser agent 201. In the case that the mouse position is outside a web page or outside the browser, advertisements will be hidden. In the current example, the mouse position is over empty space.

The cursor tracking ad 741 behavior is also part of the sample web page 202. The cursor tracking behavior means that the ad will follow the mouse position in real-time as the user moves their mouse position. The ad may be at a offset as shown in the Figure but need not follow this convention. As the mouse position 731 moves over content, the presentation system 320, the advertisement is hidden. When the mouse position 731 moves over empty space, the ad appears and follows the mouse position. If the user clicks anywhere in the empty space, the destination logic 404 decides where to send the user's web browser agent 201.

The margin ad 751 shown in the sample web page 202 is very similar to the cursor tracking ad 741 with several exceptions. The first exception is that the ad remains in a fixed position rather than following the cursor. The second exception is that the user may click the advertisement in addition to clicking the empty space to indicate interest.

FIG. 8 is a sample of three advertising formats which may be presented using the presentation system 303. Three sample formats include a textual ad 801, a graphical ad 802, and a feedback ad 803. These formats are not exhaustive of all available ad formats, and many other examples exist including video ads, rich media ads, among many examples. Ads share the logo of Empty Space Advertisements to let the user clearly know that what they see appearing out of the empty space is an advertisement. Additionally, the tag line “click to view, shake to remove” informs the user how to find out more information about the ad. The “shake to remove” statement references the ability of the user to dismiss the advertisement by moving the mouse rapidly within a short period of time. Finally dimensions of each ad are shown to better visualize the formats. As mentioned before, ads may appear in many dimensions.

Textual ad 801 shows an example of how textual ads would be displayed by the presentation system 303. A title, several lines of text, and a URL are available for the advertiser to customize at their choosing. Content is stored in the ad server's ad store 502. These textual ads are similar to Google's textual ads.

Image ads 802 are very similar to the textual ad except an image takes the place of the text. The images to be presented can be of arbitrary size. The images presented can also change as time progresses or based on user input. The presentation system 303 is responsible for rendering the images as needed.

Finally, the feedback ad 803 allows the user to rate the content on the current page to provide valuable data to the website owner. The user can interact with this advertisement by either clicking the rating component₌shown by clicking the appropriate number of stars the content should be rated. Alternate inputs such as the keyboard could also be used.

The processes described above may be implemented using computer-executable instructions in software or firmware, but may also be implemented in other ways, such as with programmable logic, electronic circuitry, or the like. In some alternative embodiments, certain of the operations may even be performed with limited human intervention. Moreover, the process is not to be interpreted as exclusive of other embodiments, but rather is provided as illustrative only.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for presenting an advertisement on a web page, comprising:
rendering the web page for visual presentation, the rendered web page comprising content and white space, the white space being substantially devoid of content; and
causing the advertisement to be displayed on the web page in the white space.

2. A system for online advertising, comprising:
a web browsing agent for execution on a client computer and configured to load a web page, the web page including client-side executable code configured to request an appropriate ad to be served from an ad server;
a client side code interpreter for executing the client-side executable code;
a empty space detection system configured to distinguish content elements of the web page from empty space on the web page; and
a presentation system configured to present the ad at least proximate to the empty space on the web page.

3. The system of claim 2, further comprising a usage data tracking system configured to track for the advertisements and to report to the ad server.
